(19) United States
(12) Patent Application Publication
(10) Pub. No.: US 2024/0411299 A1
(43) Pub. Date: Dec. 12, 2024

(54) CONTROL SYSTEM, CONTROL METHOD, AND CONTROL PROGRAM

(71) Applicant: NIPPON TELEGRAPH AND TELEPHONE CORPORATION, Tokyo (JP)

(72) Inventors: Tetsuya FUKUDA, Musashino-shi, Tokyo (JP); Masahiro MARUYOSHI, Musashino-shi, Tokyo (JP)

(73) Assignee: NIPPON TELEGRAPH AND TELEPHONE CORPORATION, Tokyo (JP)

(21) Appl. No.: 18/702,333

(22) PCT Filed: Oct. 27, 2021
(86) PCT No.: PCT/JP2021/039705

§ 371 Date: Apr. 18, 2024

(51) Int. Cl. G05B 23/02

(52) U.S. Cl. CPC G05B 23/0221; G05B 23/0272

(57) ABSTRACT

A control system controls a coupled simulation in which one simulation is constructed by combination of a plurality of simulators, the control system including processing circuitry configured to execute simulation in the plurality of simulators and acquires information including state variables in calculation processes in the simulators, manage a logical time for each of the simulators according to a causal relationship between the plurality of simulators, and instructs the wrapper unit to execute the simulation in each of the simulators by using the logical time, control information exchange between the plurality of simulators according to the causal relationship between the plurality of simulators and acquires cooperation information, which is information exchanged between the simulators, and analyze presence or absence of an abnormality in the coupled simulation on a basis of the state variables in the calculation processes and the cooperation information.

### TECHNICAL FIELD

The present invention relates to a control system, a control method, and a control program.

### BACKGROUND ART

Conventionally, in the field of coupling technology, in which a plurality of simulation tools is combined to construct one simulation, the Functional Mock-up Interface (FMI), which is a standard formulated to handle continuous time simulation, and the High Level Architecture (HLA), which is a standard formulated to perform discrete time event-based simulation, have been proposed. FMI is a standard formulated to handle continuous time simulation. HLA is a standard formulated to perform discrete time event-based simulation.

Conventionally, as coupling technologies, there are a technology in which information is exchanged between simulators at a predetermined timing while the plurality of simulators is operated independently, and a technology in which each simulator gives information received from another simulator as an input to the simulator and performs calculation until the next information exchange.

### CITATION LIST

### Non Patent Literature

Non Patent Literature 1: Modelica Association, “Functional Mock-up Interface for Model Exchange and Co-Simulation Document version: 2.0.2”, [online], [Searched on Oct. 15, 2021], the Internet <URL: https://github.com/modelica/fmi-standard/releases/download/v2.0.2/FMI-Specification-2.0.2.pdf e>
Non Patent Literature 2: IEEE Computer Society, “IEEE Standard for Modeling and Simulation (M&S) High Level Architecture (HLA) Federate Interface Specification”. Non Patent Literature 3: Modelica Association, “DCP Specification document Version 1.0”, [online], [Searched on Oct. 15, 2021], the Internet <URL: https://dcp-standard.org/assets/specification/DCP_Specification_v1.0.pd f>

### SUMMARY OF INVENTION

### Technical Problem

In a coupled simulation, as the number of simulator elements participating in calculation increases, it becomes difficult to perform analysis when a problem occurs in terms of speed and accuracy. However, FMI and HLA do not have a function of performing analysis, and it is necessary for a user himself/herself to collect information and perform analysis. In addition, the Distributed Co-Simulation Protocol (DCP) exists as a communication protocol for coupling including specifications related to monitoring of satisfaction of real-time requirements. However, in DCP, although it is possible to determine which simulator does not satisfy the specifications, further analysis is not possible.

As described above, there is no analysis technology for a coupled simulation, which is likely to be complicated, and there is a case where management and improvement of a system cannot be smoothly executed by a user.

The present invention has been made in view of the above, and an object thereof is to provide a control system, a control method, and a control program capable of providing an analysis technology for a coupled simulation.

### Solution to Problem

In order to solve the above-described problems and achieve the object, a control system according to the present invention is a control system that controls a coupled simulation in which one simulation is constructed by combination of a plurality of simulators, the control system including: a wrapper unit that executes simulation in the plurality of simulators and acquires information including state variables in calculation processes in the simulators; a first control unit that manages a logical time for each of the simulators according to a causal relationship between the plurality of simulators, and instructs the wrapper unit to execute the simulation in each of the simulators by using the logical time; a second control unit that controls information exchange between the plurality of simulators according to the causal relationship between the plurality of simulators and acquires cooperation information, which is information exchanged between the simulators; and an analysis unit that analyzes presence or absence of an abnormality in the coupled simulation on the basis of the state variables in the calculation processes and the cooperation information.

### Advantageous Effects of Invention

According to the present invention, it is possible to provide an analysis technology for a coupled simulation.

### BRIEF DESCRIPTION OF DRAWINGS

FIG. 1 is a block diagram illustrating an example of a configuration of a control system according to an embodiment.

FIG. 2 is a block diagram illustrating an example of a configuration of a simulator wrapper unit.

FIG. 3 is a block diagram illustrating an example of a configuration of an execution control unit.

FIG. 4 is a block diagram illustrating an example of a configuration of a data distribution control unit.

FIG. 5 is a block diagram illustrating an example of a configuration of an execution management unit.

FIG. 6 is a block diagram illustrating an example of a configuration of a profiling unit.

FIG. 7 is a block diagram illustrating an example of a configuration of a presentation unit.

FIG. 8 is a sequence diagram illustrating a processing procedure during a normal operation in the control system.

FIG. 9 is a sequence diagram illustrating a processing procedure during an abnormal operation in the control system.

FIG. 10 is a sequence diagram illustrating a processing procedure of presentation processing in the control system.

FIG. 11 is a diagram illustrating an example of a graph indicating a calculation result.

FIG. 12 is a diagram illustrating an example of an analysis result.

FIG. 13 is a diagram for describing communication processing in the control system.

FIG. 14 is a diagram for describing communication processing in the control system.

FIG. 15 is a diagram illustrating an example of a computer in which a program is executed and thus each component of the control system is implemented.

### DESCRIPTION OF EMBODIMENTS

Hereinafter, an embodiment of the present invention will be described in detail with reference to the drawings. Note that the present invention is not limited by this embodiment. Furthermore, in the description of the drawings, the same portions are denoted by the same reference signs.

### EMBODIMENT

The present embodiment relates to a basic technology for constructing a simulation across fields by performing coupling in which simulators constructed with high expertise in a plurality of different specialized areas are combined. In the embodiment, a control method and an abnormality analysis method for a coupled simulation in which a plurality of simulators is combined and one simulation is constructed will be described.

Note that there is no essential difference between a case where the coupled objects are simulators and a case where the coupled objects are actual systems, and thus, in the present embodiment, the simulators include simulators and actual systems. Furthermore, the coupling includes strong coupling in which a plurality of equations of a plurality of simulations can be collectively calculated by one solver, and weak coupling in which equations are solved by different solvers and cooperated at a traction level. Among them, the present embodiment relates to weak coupling. There are three types of simulation: continuous time simulation, discrete time event-based simulation, and hybrid simulation combining them, and the present embodiment is directed to all of them.

### [Control System]

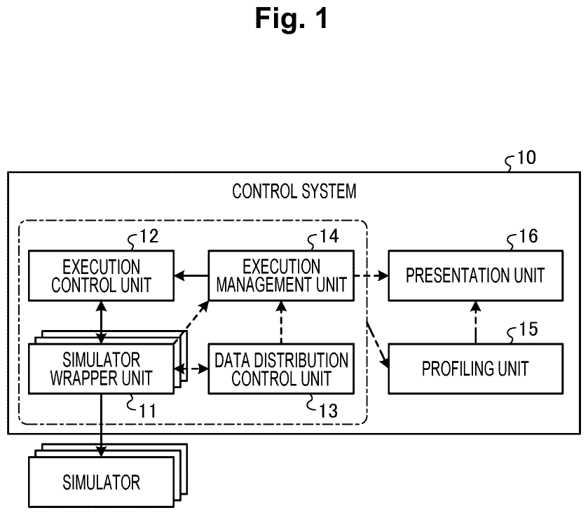

Next, a control system according to the embodiment will be described. FIG. 1 is a block diagram illustrating an example of a configuration of the control system according to the embodiment. Note that, in the following block diagrams, a solid line means a notification/processing call in execution control, a broken line means transmission and reception of data, and an alternate long and short dash line means profiling information acquisition.

Each component of a control system 10 according to the embodiment is implemented by, for example, a predetermined program being read by a computer or the like including a read only memory (ROM), a random access memory (RAM), a central processing unit (CPU), and the like, and the CPU executing the predetermined program. Furthermore, each component of the control system 10 includes a communication interface that transmits and receives various types of information to and from another device connected via a network or the like.

As illustrated in FIG. 1, the control system 10 includes simulator wrapper units 11 (wrapper unit), an execution control unit 12 (first control unit), a data distribution control unit 13 (second control unit), an execution management unit 14 (analysis unit), a profiling unit 15 (monitoring unit), and a presentation unit 16. In the embodiment, as an example, a case where the control system 10 is a master-slave architecture will be described as an example.

The simulator wrapper units 11 are configured by a plurality of slaves that executes simulation in a plurality of simulators, and have a function of wrapping the simulators. In the simulator wrapper units 11, each slave exchanges information with another simulator and executes calculation of its own simulator. In a case where the calculation of a time section of its own simulator is completed, each of the simulator wrapper units 11 outputs the calculation result to another simulator via the data distribution control unit 13 (described later). The simulator wrapper units 11 then acquire information on state variables in calculation processes in the simulators together with a calculation result of a coupled simulation for analysis, and transmit the information to the execution management unit 14.

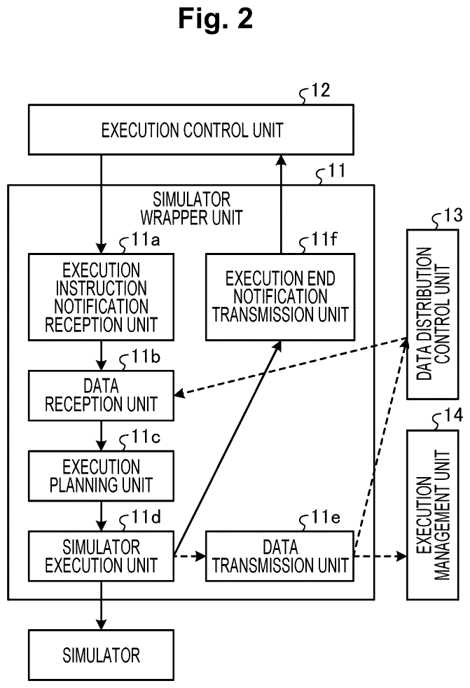

FIG. 2 is a block diagram illustrating an example of a configuration of one of the simulator wrapper units 11. As illustrated in FIG. 2, each of the slaves functioning as the simulator wrapper units 11 includes an execution instruction notification reception unit 11a, a data reception unit 11b, an execution planning unit 11c, a simulator execution unit 11d, a data transmission unit 11e, and an execution end notification transmission unit 11f.

The execution instruction notification reception unit 11a receives an execution instruction from the execution control unit 12. The data reception unit 11b receives an input to its own simulator from the data distribution control unit 13. In a case where a discrete time event is received from another simulator, the execution planning unit 11c divides a step of its own simulator at the time of the discrete time event and executes simulation. The execution planning unit 11c reflects an input from another simulator on the accurate time of its own simulator.

The simulator execution unit 11d performs input and output to the simulator and executes the simulation in the simulator. The data transmission unit 11e acquires an execution result of the simulator as an output, arbitrarily converts the execution result, and transmits the converted result to the data distribution control unit 13.

The data transmission unit 11e transmits information on a state variable in a calculation process in the simulator to the execution management unit 14. The execution end notification transmission unit 11f transmits a notification indicating the completion of the simulator execution instruction to the execution control unit 12. Note that, in the simulator wrapper units 11, for example, a P2P type communication scheme is applied to communication between a plurality of simulators, thereby enabling collective communication directly between slaves without interposition of a master.

The execution control unit 12 manages a logical time for each simulator according to a causal (dependency) relationship between the plurality of simulators, and instructs the simulator wrapper units 11 to execute or re-execute the simulation in the simulators using the logical time. The execution control unit 12 functions as, for example, a master of the coupled simulation.

In the case of a normal operation, the execution control unit 12 performs time adjustment of the logical time of each simulator, grasps the operation of each simulator along the time of the entire coupled simulation, and instructs each simulator to execute the simulation. In the case of an abnormal operation, that is, in a case where an abnormality is detected in the execution management unit 14 (described later), the execution control unit 12 rolls back the simulator in which the abnormality has been detected by the execution management unit 14 and all the simulators depending on the simulator in which the abnormality has been detected by the execution management unit 14 to any timing and re-executes the simulation in response to an instruction of re-execution by the execution management unit 14.

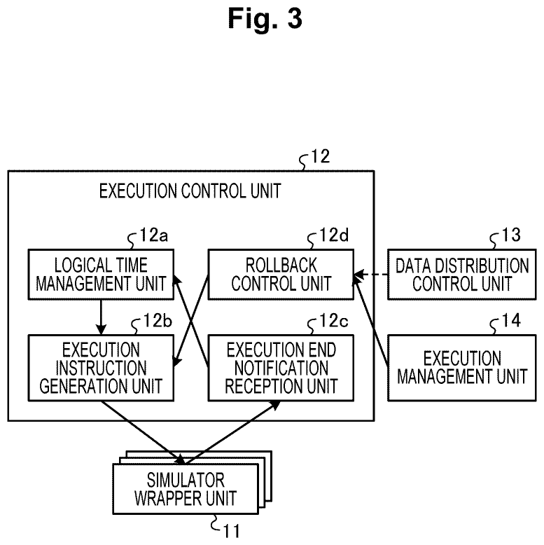

FIG. 3 is a block diagram illustrating an example of a configuration of the execution control unit 12. As illustrated in FIG. 3, the execution control unit 12 includes a logical time management unit 12a, an execution instruction generation unit 12b, an execution end notification reception unit 12c, and a rollback control unit 12d.

The logical time management unit 12a manages a logical time for the simulators. The execution instruction generation unit 12b determines parallelism and an execution order in an execution method of the simulators according to a causal relationship between the simulators, and transmits, as an execution instruction, an execution instruction notification to one of the simulator wrapper units 11 corresponding to a target simulator. The execution end notification reception unit 12c receives an execution end notification of the simulator wrapper unit 11 and advances the logical time.

The rollback control unit 12d sets the causal relationship between the simulators. In a case where an abnormality is detected in the execution management unit 14, the rollback control unit 12d rolls back the simulator in which the abnormality has been detected by the execution management unit 14 and all the simulators depending on the simulator in which the abnormality has been detected by the execution management unit 14 to any timing, and enables re-execution of the simulation. At this time, the rollback control unit 12d acquires past information from the data distribution control unit 13.

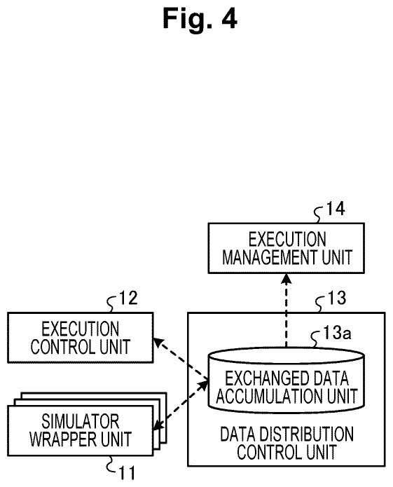

The data distribution control unit 13 controls exchange of information according to the causal relationship between the plurality of simulators. The data distribution control unit 13 controls exchange of information between the simulators, acquires cooperation information, which is information exchanged between the simulators, and transmits the cooperation information to the execution management unit 14. FIG. 4 is a block diagram illustrating an example of a configuration of the data distribution control unit 13. As illustrated in FIG. 4, the data distribution control unit 13 includes an exchanged data accumulation unit 13a.

The exchanged data accumulation unit 13a acquires information from an actual system and feeds back information from a simulator to an actual system. The exchanged data accumulation unit 13a performs information distribution between simulators via the master or directly between slaves. The data distribution control unit 13 uses a queue mechanism in a case where communication is performed via the master. Furthermore, the data distribution control unit uses a Message Passing Interface (MPI) mechanism in a case where communication is performed directly between slaves. A P2P type communication scheme is applied to communication between the simulator wrapper units 11 and the data distribution control unit 13, thereby enabling direct collective communication between slaves.

The execution management unit 14 analyzes the calculation accuracy of the coupled simulation executed in the simulator wrapper units 11. The execution management unit 14 analyzes the presence or absence of an abnormality in the coupled simulation on the basis of the state variables in the calculation processes and the cooperation information. In a case where the execution management unit 14 detects a discontinuous singular point in the locus of change of a state variable on the basis of the state variables in the calculation processes, and determines that the change of the state variable at the singular point is derived from information exchange of the coupled simulation on the basis of the cooperation information, the execution management unit 14 detects an abnormality having occurred in the coupled simulation at the generation timing of the singular point. In a case where an abnormality is detected, the execution management unit 14 instructs the execution control unit 12 to re-execute simulation for the simulator in which the abnormality has been detected and all the simulators depending on the simulator in which the abnormality has been detected.

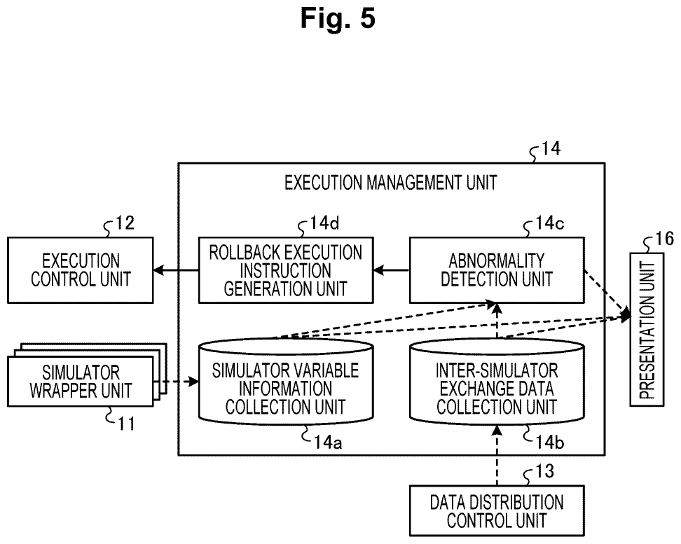

FIG. 5 is a block diagram illustrating an example of a configuration of the execution management unit 14. As illustrated in FIG. 5, the execution management unit 14 includes a simulator variable information collection unit 14a, an inter-simulator exchange data collection unit 14b, an abnormality detection unit 14c, and a rollback execution instruction generation unit 14d.

The simulator variable information collection unit 14a receives the state variables in the calculation processes from the simulator wrapper units 11, and thus collects execution information of the simulators executed in the simulator wrapper units 11. The execution information of the simulators is information regarding change of the state variables in the calculation processes in the simulators. The simulator variable information collection unit 14a outputs the collected execution information of the simulators to the presentation unit 16.

The inter-simulator exchange data collection unit 14b receives the cooperation information from the data distribution control unit 13, and thus collects the cooperation information at the time of coupling. The inter-simulator exchange data collection unit 14b outputs the collected cooperation information to the presentation unit 16.

The abnormality detection unit 14c applies an analysis algorithm to the execution information of the simulators to detect an abnormality of the coupled simulation. The abnormality detection unit 14c outputs the analysis result to the presentation unit 16. In a case where the abnormality detection unit 14c detects a discontinuous singular point in the locus of change of a state variable on the basis of the state variables in the calculation processes, and determines that the change of the state variable at the singular point is derived from information exchange of the coupled simulation on the basis of the cooperation information, the abnormality detection unit 14c detects an abnormality having occurred in the coupled simulation at the generation timing of the singular point.

In a case where an abnormality is detected by the abnormality detection unit 14c, the rollback execution instruction generation unit 14d instructs the execution control unit 12 to execute simulation again at an appropriate timing for the simulator in which the abnormality has been detected by the abnormality detection unit 14c and all the simulators depending on the simulator in which the abnormality has been detected by the abnormality detection unit 14c.

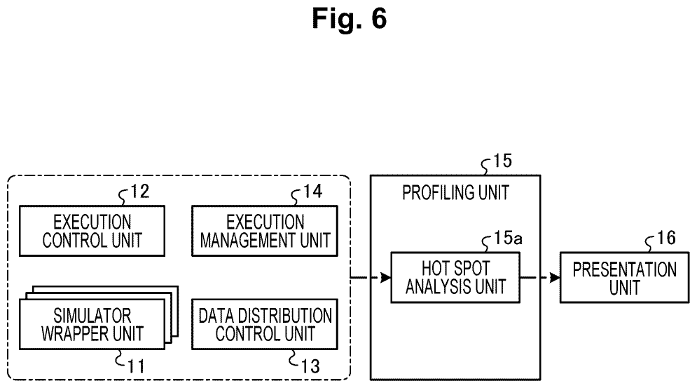

The profiling unit 15 monitors the speed of the coupled simulation executed in the simulator wrapper units 11. The profiling unit 15 identifies an execution hot spot in the coupled simulation. The execution hot spot is the most time-consuming part in the execution. FIG. 6 is a block diagram illustrating an example of a configuration of the profiling unit 15. As illustrated in FIG. 6, the profiling unit 15 includes a hot spot analysis unit 15a.

The hot spot analysis unit 15a comprehensively profiles the coupled system and all the individual simulators, and identifies the execution hot spot. The hot spot analysis unit 15a outputs the identified execution hot spot to the presentation unit 16. Note that the identification of the execution hot spot may be executed by the presentation unit 16.

The presentation unit 16 visualizes at least one of the state variables in the calculation processes in the simulators, the cooperation information, and the analysis result by the execution management unit 14, and presents the visualized one to a user. The presentation unit 16 visualizes the simulation result, the simulation execution information, the analysis result, and the information regarding the execution hot spot such that the user can visually recognize them.

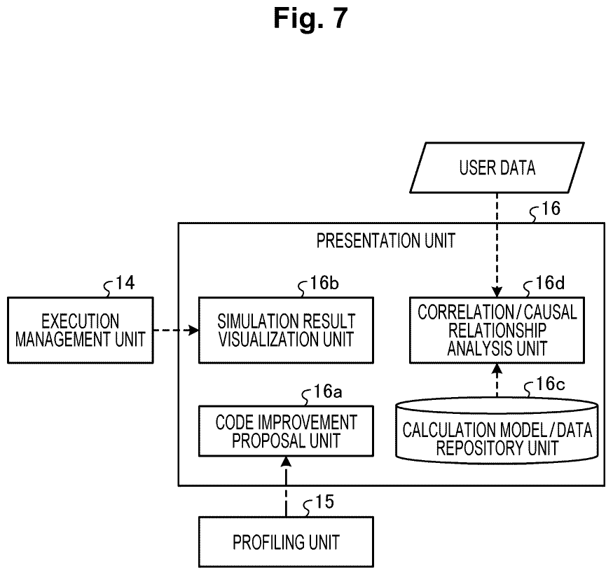

FIG. 7 is a block diagram illustrating an example of a configuration of the presentation unit 16. As illustrated in FIG. 7, the presentation unit 16 includes a code improvement proposal unit 16a, a simulation result visualization unit 16b, a calculation model/data repository unit 16c, and a correlation/causal relationship analysis unit 16d.

The code improvement proposal unit 16a makes an improvement proposal for an information code received from the profiling unit 15 and outputs proposal contents. The code improvement proposal unit 16a extracts a cause of the execution hot spot identified by the profiling unit 15 and presents an improvement proposal. The simulation result visualization unit 16b presents the execution information and analysis information output from the execution management unit 14 to the user.

The calculation model/data repository unit 16c discloses a combination of a simulation model and data executed in the system in the past in a form available to the user. At this time, the system provider side may prepare some disclosure examples in advance. The correlation/causal relationship analysis unit 16d provides a function of analyzing a correlation and a causal relationship between variables in user data.

### [Normal Operation]

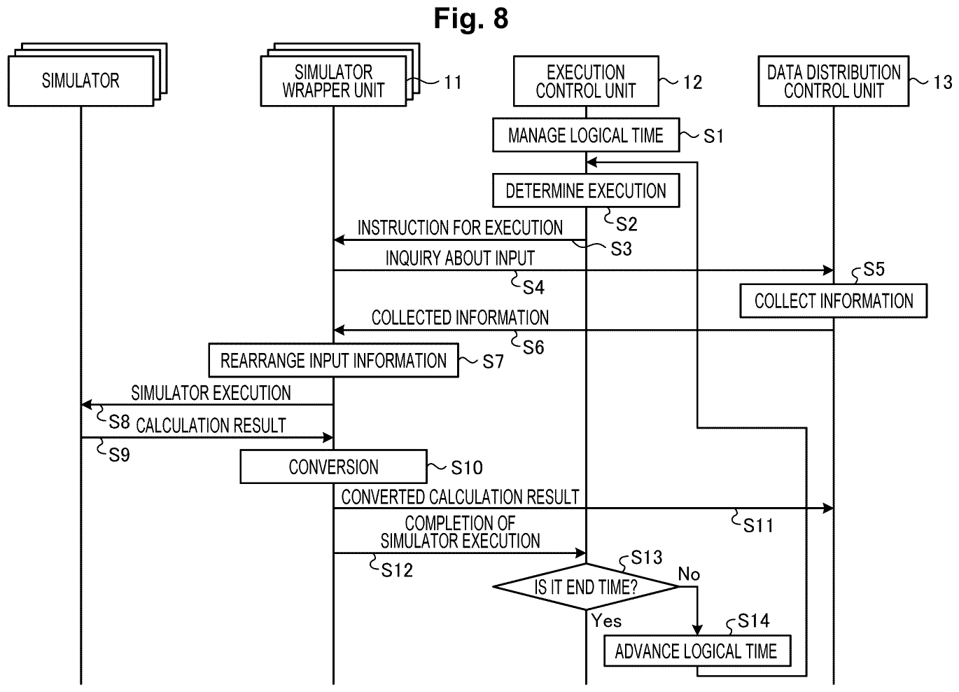

Next, a normal operation in the control system 10 will be described. FIG. 8 is a sequence diagram illustrating a processing procedure during a normal operation in the control system 10.

First, in the execution control unit 12, the logical time management unit 12a manages the progress status of each simulator as a unified index (logical time) (step S1). The execution instruction generation unit 12b determines a simulator set to be executed at a certain time, an execution order of the simulator set, and whether to execute the simulator set in parallel according to an execution interval and a causal relationship of the simulators (step S2). The causal relationship is a restriction that a certain simulator must necessarily be executed after another specific simulator. The execution instruction generation unit 12b transmits information that actually instructs the simulator wrapper units 11 to execute simulation to the simulator wrapper units 11 according to the determined execution order (step S3).

In each of the simulator wrapper units 11, the execution instruction notification reception unit 11a receives the execution instruction from the execution control unit 12. The simulator execution unit 11d inquires of the data distribution control unit 13 and confirms whether inputs to its own simulator or an actual system at that time have been prepared (step S4).

In the data distribution control unit 13, the exchanged data accumulation unit 13a receives a request from one of the simulator wrapper units 11, and collects information as an input to the simulator managed by the simulator wrapper unit 11 as a request source in both continuous time variable information and discrete time event information (step S5). At this time, the exchanged data accumulation unit 13a may transfer data via a master or directly exchange data between slaves.

In the case of transferring data via the master, the exchanged data accumulation unit 13a prepares a common access region such as a message queue or a database, or prepares a variable in a program. In the case of transferring data via slaves, the exchanged data accumulation unit 13a performs P2P communication using a mechanism such as MPI, for example, as described above, but the communication mechanism is not particularly limited. The exchanged data accumulation unit 13a may perform collective communication between slaves. Note that, in the case of P2P communication, since the data transfer is a push type exchange, the collection is synonymous with waiting for the end of execution of another simulator that performs input. The exchanged data accumulation unit 13a outputs the collected information to the simulator wrapper unit 11 (step S6).

In the simulator wrapper unit 11, the execution planning unit 11c first refers to the data received from the data distribution control unit 13 and rearranges the input information in chronological order (step S7). The execution planning unit 11c determines whether there is a discrete time event having a time during a step of the simulator managed by the execution planning unit 11c (when the step is defined as t1≤t<t2, a time T at which t1<T<t2 is satisfied is referred to as a time “during” the step), and performs control, in a case where there is such a discrete time event, such that the original step is divided into step execution, discrete time event information reflection (input), step execution, and the like. Note that, even in a case where the management target is an actual system, the execution planning unit 11c reflects input information to the system in a similar procedure.

The simulator execution unit 11d executes the simulator on the basis of the division result of the execution planning unit 11c (step S8), and ends the calculation by the simulator when the time of the simulator reaches an end time of the step before the division.

The data transmission unit 11e receives the calculation result by the simulator execution unit 11d (step S9), converts the calculation result by any method set by the user (step S10), and transmits the converted calculation result to the data distribution control unit 13 (step S11). In this case, the calculation result may be transferred via a file or via communication via a network conforming to a standard such as MPI. In the transmission of the calculation result to the data distribution control unit 13, the user can select, as described above, either transmission to the message queue or the database or transmission using P2P communication such as MPI, and execute the selected transmission. The execution end notification transmission unit 11f transmits a notification indicating the completion of the simulator execution instruction to the execution control unit 12 (step S12).

In the execution control unit 12, when the execution end notification reception unit 12c receives the end notification from the simulator, it is determined whether it is the end time of the entire coupled simulation (step S13).

In a case where it is not the end time of the entire coupled simulation (step S13: No), the execution control unit 12 advances the logical time of the simulator from which the end notification has been received (step S14), returns to step S2, creates a new execution instruction, and issues the execution instruction again according to the time and the causal relationship. The control system 10 repeats the processing of steps S2 to S14 until the end time of the entire coupled simulation is reached.

### [Processing During Abnormal Operation]

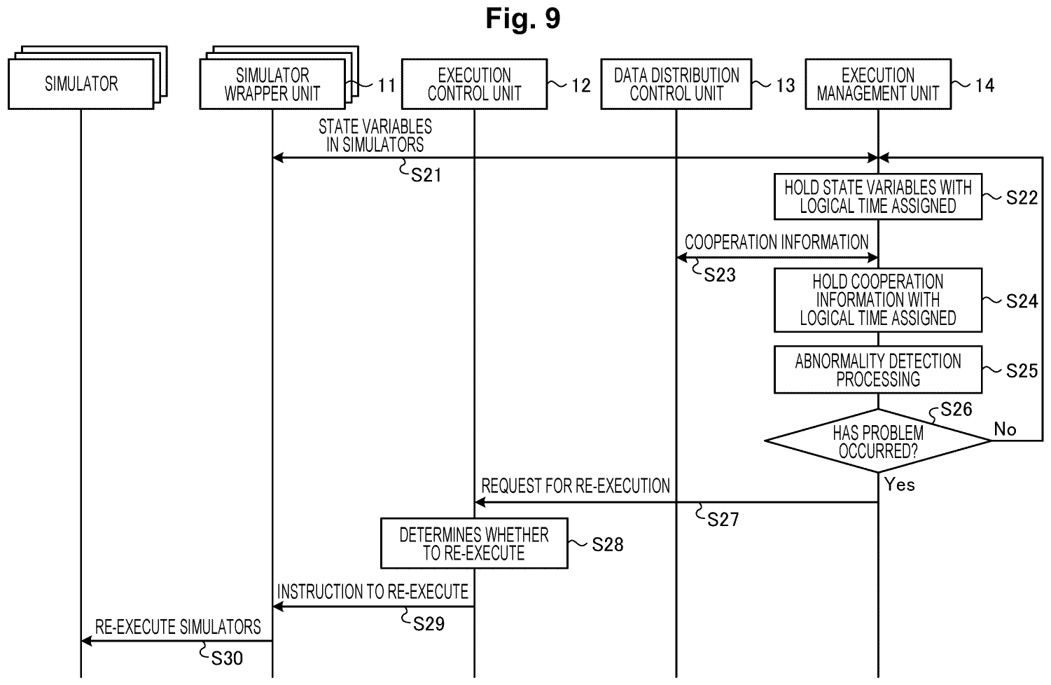

Next, processing during an abnormal operation in the control system 10 will be described. FIG. 9 is a sequence diagram illustrating a processing procedure during an abnormal operation in the control system 10.

In the execution management unit 14, the simulator variable information collection unit 14a collects the state variables in the simulators executed by the simulator wrapper units 11 in the normal operation in units of steps of the simulators (step S21), and holds the state variables as information D1 to which the logical time is assigned (step S22).

In addition, the inter-simulator exchange data collection unit 14b collects cooperation information between the simulators transmitted and received by the data distribution control unit 13 in the normal operation (step S23), and holds the cooperation information as information D2 to which the logical time is assigned (step S24). Either the processing in steps S21 and S22 or the processing in steps S23 and S24 may be performed first, or may be performed in parallel.

The abnormality detection unit 14c uses information of the calculation result of the information D1 to determine whether there is an abnormal part in the locus of change of each state variable, and uses information of the information D2 to perform abnormality detection processing of determining whether the abnormal part is a problem derived from coupling (step S25).

The abnormality detection unit 14c mainly executes detection of discontinuous singular points as abnormality detection processing. As the detection of singular points, the abnormality detection unit 14c may use, for example, an abnormality detection algorithm of time-series data such as discrete wavelet transform or singular spectrum transform, or may use another algorithm as long as singular points can be detected.

By using the time information of the information D2 together with the detection results of singular points by the abnormality detection algorithm, the abnormality detection unit 14c narrows down the abnormality detection results to only those derived from information exchange of the coupled simulation, and analyzes them separately from abnormalities derived from the simulators. The abnormalities derived from the simulators are abnormalities that are considered to be occurring regardless of the coupling.

Furthermore, in a case where data for deviation comparison (actual measurement data or the like) is set in advance by the user, the abnormality detection unit 14c compares the information D1 with the data for deviation comparison, and can detect an abnormality in a case where the magnitude of the deviation exceeds a predetermined threshold value.

The rollback execution instruction generation unit 14d determines whether a problem (abnormality) has occurred as a result of the analysis by the abnormality detection unit 14c (step S26). In a case where a problem has occurred (step S26: Yes), the rollback execution instruction generation unit 14d transmits, to the execution control unit 12, a request for re-execution from a step including the time when the problem has occurred, for the simulator in which the problem has occurred and all the simulators depending on (having a causal relationship with) the simulator in which the problem has occurred (step S27). In a case where no problem has occurred (step S26: No), the execution management unit 14 returns to step S21 and collects the state variables in the simulators.

When the rollback control unit 12d receives the re-execution request from the execution management unit 14, the execution control unit 12 temporarily suspends the execution of the simulator in which the problem has occurred and all the simulators depending on the simulator in which the problem has occurred, and determines whether to re-execute the simulation (step S28).

In a case where the problem depends on discontinuity, the rollback control unit 12d reinitializes the simulator in which the problem has occurred and all the simulators depending on the simulator in which the problem has occurred, and then gives an instruction to re-execute the simulation (step S29). In a case where the problem is a deviation from a comparison source data, the rollback control unit 12d generates a new initial value from the comparison data and the simulation result, reinitializes the simulator in which the problem has occurred and all the simulators depending on the simulator in which the problem has occurred, by using the generated initial value, and executes the simulation again (step S29). Note that the rollback control unit 12d may regard the data for comparison as correct answer data and set the data as an initial value. In addition, the rollback control unit 12d may estimate the initial value by performing data assimilation using the data for comparison and the simulation result. The simulator wrapper units 11 execute the corresponding simulators according to the re-execution instruction (step S30).

### [Presentation Processing]

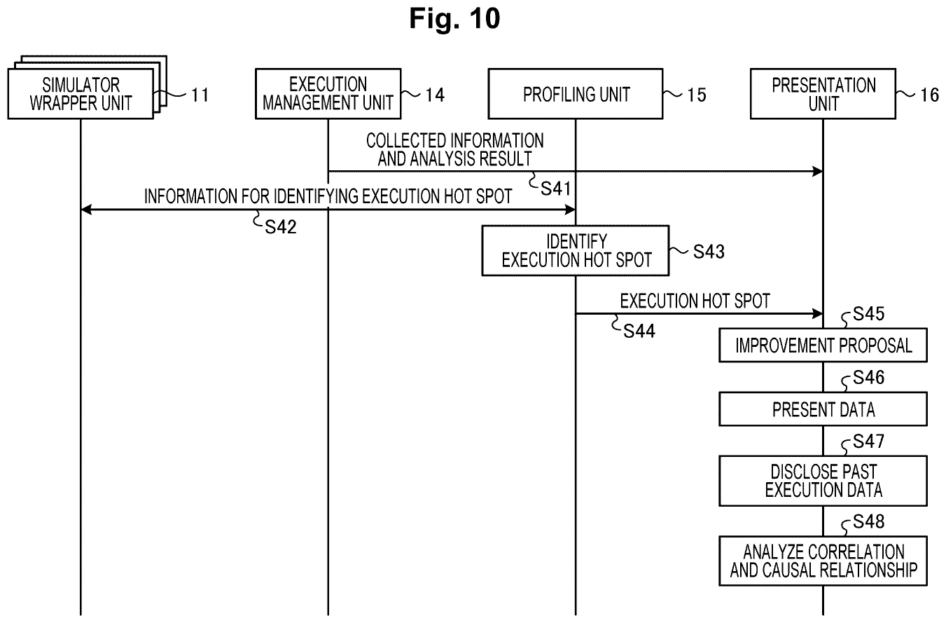

Next, processing until the control system 10 presents the analysis result and the like to the user will be described. FIG. 10 is a sequence diagram illustrating a processing procedure of the presentation processing in the control system 10.

The execution management unit 14 outputs the information collected by the simulator variable information collection unit 14a and the inter-simulator exchange data collection unit 14b and the analysis result by the abnormality detection unit 14c to the presentation unit 16 (step S41). The execution management unit 14 outputs, for example, the state variables in the calculation processes, the cooperation information, and the analysis result by the abnormality detection unit 14c to the presentation unit 16. The execution management unit 14 may collectively transmit the information at the end of execution of the entire simulation (normal end or abnormal end), or may transmit the information at predetermined intervals.

In the profiling unit 15, the hot spot analysis unit 15a comprehensively profiles the coupled simulation and all the individual simulators, and collects information that can identify the most time-consuming part in the execution (execution hot spot) (step S42). In addition, in a case where a user who can determine an execution hot spot performs detailed profiling, the hot spot analysis unit 15a also collects detailed profiling information. Note that a profiler used by the hot spot analysis unit 15a may be a known profiler or may be customized by the user, and may be defined and selected by the user.

The hot spot analysis unit 15a identifies an execution hot spot on the basis of the collected information (step S43). The hot spot analysis unit 15a outputs information on the identified execution hot spot to the presentation unit 16 (step S44). At this time, the hot spot analysis unit 15a may also output the collected information to the presentation unit 16 together with the information on the execution hot spot. Note that the code improvement proposal unit 16a of the presentation unit 16 may cause the hot spot analysis unit 15a to identify a hot spot.

In the presentation unit 16, in a case where the code improvement proposal unit 16a performs detailed profiling, a cause of the execution hot spot, which is a bottleneck, is extracted, and an improvement proposal corresponding thereto is presented (step S45). In a case where there is a part mainly related to the cache miss ratio and the communication time as a cause, the code improvement proposal unit 16a provides known information to each. For example, in a case where the cache miss ratio is high, the code improvement proposal unit 16a presents a method of performing calculation with a matrix divided, such as cache tiling. Furthermore, in a case where there is a part related to the communication time, the code improvement proposal unit 16a presents a method of dividing processing for reducing the communication amount, overlapping between calculation and communication, or the like.

The simulation result visualization unit 16b plots each piece of information by the simulator variable information collection unit 14a, the inter-simulator exchange data collection unit 14b, the abnormality detection unit 14c, and the like, and visually presents the data to the user (step S46). For example, the simulation result visualization unit 16b displays and outputs a graph of the calculation result and the analysis result on a display or the like.

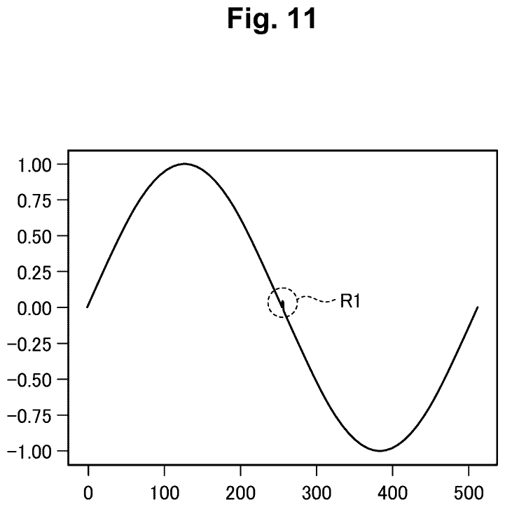

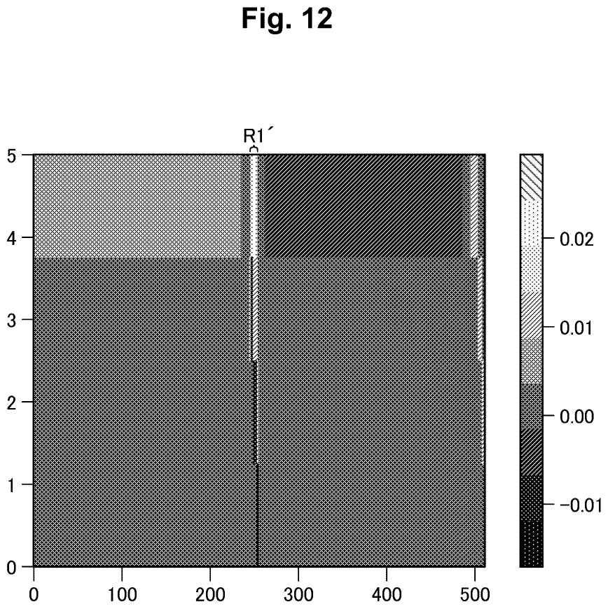

FIG. 11 is a diagram illustrating an example of the graph indicating the calculation result. FIG. 12 is a diagram illustrating an example of the analysis result. Furthermore, FIG. 12 illustrates a result of analyzing the calculation result of FIG. 11 using Discrete Wavelet Transform.

The user checks the graph indicating the calculation result illustrated in FIG. 11 and the analysis result of FIG. 12, and thus can recognize that there is a singular point in regions R1 and R1′. In addition, the simulation result visualization unit 16b presents the data before plotting such that the user can download the data before plotting, thereby enabling the user to use the data before plotting.

In the presentation unit 16, the calculation model/data repository unit 16c discloses simulation models executed by use of the control system 10 in the past, input data used for the execution, and output data as a result, in a form available to other users (step S47). Other users can acquire and use any one of the simulation models, the input data, and the output data. The simulation models also include conversion at the time of data exchange between simulators, and other users may use this part as it is or may use this part after any change. Other users can also regard an output data string as an emulator (pseudo simulator) and use the data string for coupling. Note that, in a case where the user desires not to disclose the information, the information can be undisclosed.

The correlation/causal relationship analysis unit 16d analyzes a correlation and a causal relationship between variables from disclosed input/output data and data input by any user (step S48). Note that, in the correlation/causal relationship analysis unit 16d, in addition to an existing technology, a technology introduced by the user can be applied as analysis of the correlation and the causal relationship between the variables.

### [Effects of Embodiment]

As described above, in the control system 10 according to the embodiment, the control system 10 itself manages a logical time in a plurality of simulators, executes simulation using the logical time, and acquires information including state variables in calculation processes in the simulators. In the control system 10, the control system 10 itself then controls information exchange between the simulators according to a causal relationship between the plurality of simulators and acquires cooperation information, which is information exchanged between the simulators. The control system 10 analyzes the presence or absence of an abnormality in the coupled simulation on the basis of the acquired state variables in the calculation processes and the acquired cooperation information.

Therefore, the present embodiment provides the control system 10 in which the system itself collects information necessary for analysis and analyzes the presence or absence of an abnormality in the coupled simulation. As a result, it is not necessary for a user himself/herself to perform processing of collecting various types of information for analyzing a calculation result regarding the coupled simulation, which is likely to be complicated, and processing of analyzing the presence or absence of an abnormality.

Furthermore, since the control system 10 visualizes at least one of the state variables in the calculation processes, the cooperation information, and an analysis result, and presents the visualized one to the user, the user confirms these pieces of information, and thus can efficiently proceed with system management and improvement.

The control system 10 then monitors the speed of the coupled simulation, identifies an execution hot spot, extracts a cause of the execution hot spot, and presents an improvement proposal. The control system 10 not only discloses past data and models to present combinations of proven variables, but also provides a function of analyzing a correlation/causal relationship between variables using existing data. As described above, since the control system 10 acquires, for example, comprehensive profiling in terms of speed and presents an improvement proposal, the user can efficiently manage the entire coupled simulation system and perform improvement design.

Therefore, the control system 10 analyzes the entire complicated coupled simulation system in terms of both speed and accuracy, and thus can improve productivity when the user manages and improves the system. In other words, the control system 10 automatically collects various types of information such as a simulation calculation result, exchange information at the time of coupling, and an execution profile, and provides the information to the user in a human-readable manner, so that it is possible to improve the efficiency of management and improvement of the system by the user.

In addition, in a case where an abnormality is detected, the control system 10 rolls back the simulator in which the abnormality has been detected and all the simulators depending on the simulator in which the abnormality has been detected to any timing and automatically re-executes the simulation. Therefore, according to the control system 10, the user himself/herself does not need to perform complicated and difficult processing of setting input/output of the simulators and setting re-execution of the simulation.

In addition, as the fields in which coupling is performed expand, it is difficult for a user to execute information input/output mapping between simulators, which is executed by a user in the conventional technology, and this difficulty is a hindrance to the system construction.

On the other hand, the control system 10 not only discloses past data and models to present combinations of proven variables, but also provides a function of analyzing a correlation/causal relationship between variables using existing data. Therefore, according to the control system 10, even a user who is not familiar with a plurality of fields can estimate an input/output relationship between simulators and construct a coupled simulation system by performing analysis based on a set of existing experimental data and models.

Furthermore, in the case of handling a hybrid simulation having both characteristics of a plurality of types of simulations (continuous time and discrete time), a method in which a restriction can be set by the timing of information input to another simulator or the like is adopted. As an example, it is assumed that discrete time event information is input to a continuous time simulation. In general, a continuous time simulation is performed at a certain time interval (step), and an input is received only at the time of the step, whereas a discrete time event is issued regardless of the step. For this reason, conventionally, a time lag always occurs when the continuous time simulation side tries to reflect a discrete time event. Conventionally, a time lag generated at the time of executing a hybrid simulation has been a factor of reducing the precision and accuracy of a simulation result.

On the other hand, in the control system 10, since the logical time management is performed in the plurality of simulators and the simulation is executed by use of the logical time, eliminating a time lag makes it possible to improve the precision and accuracy of a simulation result. Furthermore, in a case where one of the simulator wrapper units 11 receives a discrete time event from another simulator, the control system 10 divides a continuous time simulation step at the time of the discrete time event. Therefore, according to the control system 10, the accuracy of the coupled simulation can be improved.

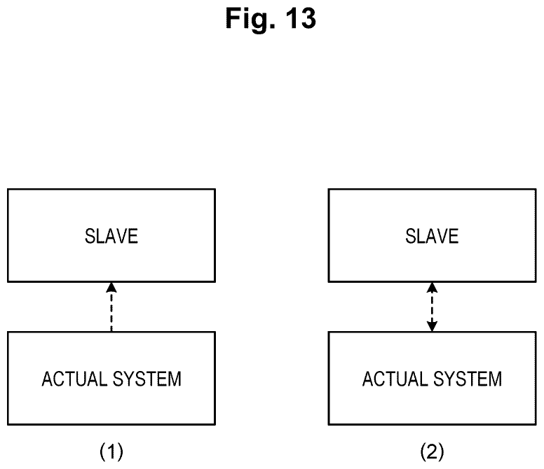

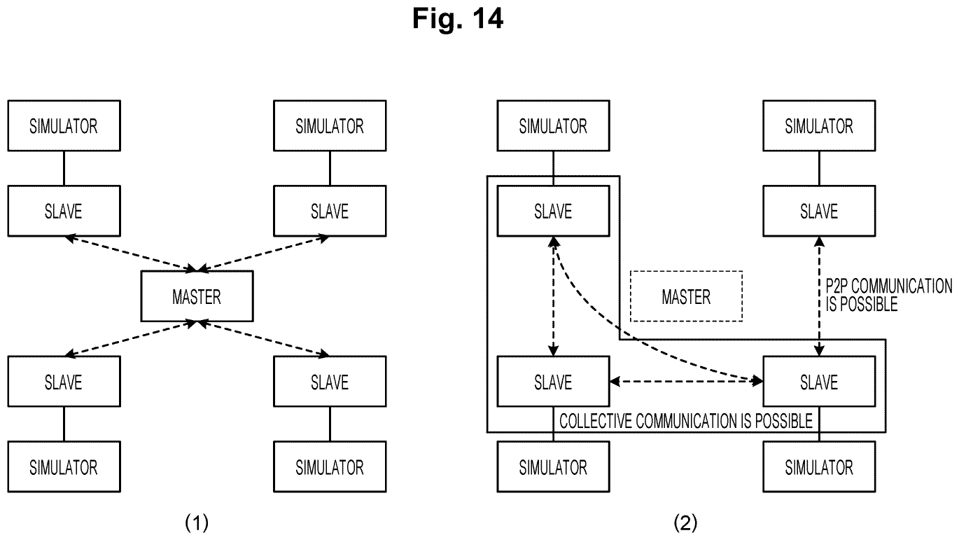

FIGS. 13 and 14 are diagrams for describing communication processing in the control system 10. Conventionally, only information acquisition from an actual system can be performed ((1) in FIG. 13). On the other hand, the control system 10 adopts a mechanism in which a region where the logic of a slave can be customized by a user is provided, and feedback to the actual system, in other words, control to the actual system can also be performed ((2) in FIG. 13). Furthermore, conventionally, communication can be performed only via a master ((1) in FIG. 14), but in the control system 10, a P2P type communication scheme is applied to communication between a plurality of simulators and communication between the simulator wrapper units 11 and the data distribution control unit 13 ((2) in FIG. 14). Therefore, the control system 10 controls the execution of the entire simulation while enabling direct P2P communication and collective communication between slaves.

Therefore, in the control system 10, overhead by interposition of a master can be reduced, and real-time oriented simulation can be executed. Since the control system 10 enables more flexible inter-slave communication than in the conventional technology, it is possible to improve the speed and easily satisfy the real-time property even in a coupled simulation between parallel large-scale workloads, in which the number of simulators and the number of parallel simulators are increased.

As described above, in the present embodiment, in addition to the control of the coupled simulation in which the simulators cooperate with each other, it is possible to assist a user to accurately and quickly control the entire coupled simulation system.

### [System Configuration of Embodiment]

Each component of the control system 10 is functionally conceptual, and does not necessarily have to be physically configured as illustrated. That is, specific forms of distribution and integration of the functions of the control system 10 are not limited to the illustrated forms, and all or part thereof can be functionally or physically distributed or integrated in any unit according to various loads, usage conditions, and the like.

Furthermore, all or any part of the processing performed in each component of the control system 10 may be implemented by a CPU, a graphics processing unit (GPU), and a program analyzed and executed by the CPU and the GPU. Furthermore, each piece of processing performed in each component of the control system 10 may be implemented as hardware by wired logic.

Moreover, among the pieces of processing described in the embodiment, all or part of the processing described as being automatically performed can be manually performed. Alternatively, all or part of the processing described as being manually performed can be automatically performed by a known method. In addition, the above-described and illustrated processing procedures, control procedures, specific names, and information including various data and parameters can be appropriately changed unless otherwise specified.

### [Program]

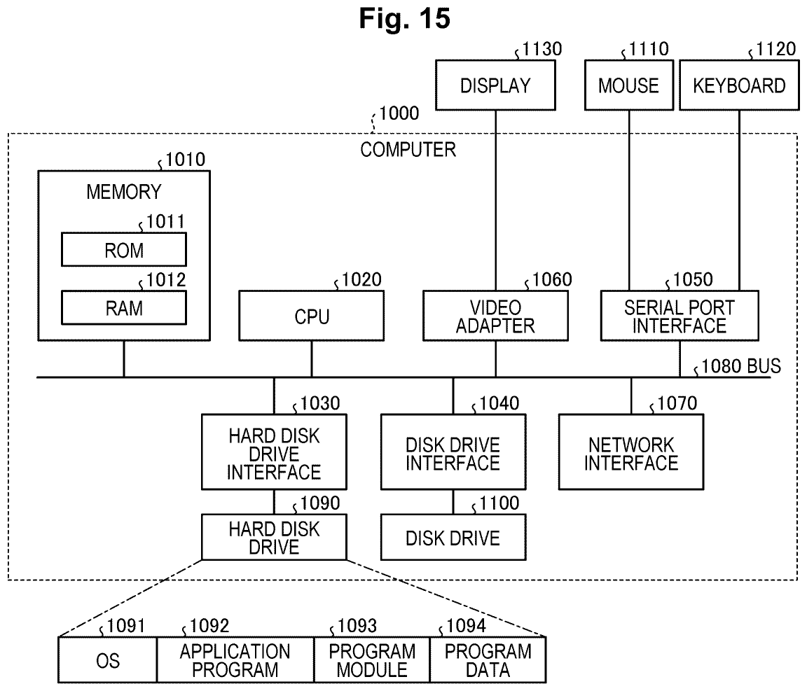

FIG. 15 is a diagram illustrating an example of a computer in which a program is executed and thus each component of the control system 10 is implemented. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected via a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program that defines each piece of processing of the control system 10 is implemented as the program module 1093 in which codes executable by the computer 1000 are described. The program module 1093 is stored in, for example, the hard disk drive 1090. For example, the program module 1093 for executing processing similar to the functional configuration of the control system 10 is stored in the hard disk drive 1090. Note that the hard disk drive 1090 may be replaced with a solid state drive (SSD).

Furthermore, setting data used in the processing of the above-described embodiment is stored as the program data 1094, for example, in the memory 1010 or the hard disk drive 1090. The CPU 1020 then reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from the another computer via the network interface 1070.

Although the embodiment to which the invention made by the present inventors is applied has been described above, the present invention is not limited by the description and drawings constituting a part of the disclosure of the present invention according to the present embodiment. That is, other embodiments, examples, operation techniques, and the like made by those skilled in the art or the like on the basis of the present embodiment are all included in the scope of the present invention.

### REFERENCE SIGNS LIST

10 Control system
11 Simulator wrapper unit
12 Execution control unit
13 Data distribution control unit
14 Execution management unit
15 Profiling unit
16 Presentation unit

1. A control system that controls a coupled simulation in which one simulation is constructed by combination of a plurality of simulators, the control system comprising:
processing circuitry configured to:
execute simulation in the plurality of simulators and acquires information including state variables in calculation processes in the simulators;
manage a logical time for each of the simulators according to a causal relationship between the plurality of simulators, and instructs the wrapper unit to execute the simulation in each of the simulators by using the logical time;
control information exchange between the plurality of simulators according to the causal relationship between the plurality of simulators and acquires cooperation information, which is information exchanged between the simulators; and
analyze presence or absence of an abnormality in the coupled simulation on a basis of the state variables in the calculation processes and the cooperation information.

2. The control system according to claim 1, wherein the processing circuitry is further configured to visualize at least one of the state variables in the calculation processes, the cooperation information, and an analysis result, and presents the visualized one to a user.

3. The control system according to claim 2, wherein the processing circuitry is further configured to
monitor a speed of the coupled simulation and identifies an execution hot spot, which is a most time-consuming part in the execution of the simulation,
extract a cause of the execution hot spot and presents an improvement proposal.

4. The control system according to claim 1, wherein the processing circuitry is further configured to
in a case where an abnormality is detected, instruct to re-execute simulation for a simulator in which the abnormality has been detected and all simulators depending on the simulator in which the abnormality has been detected, and
roll back the simulator in which the abnormality has been detected and all the simulators depending on the simulator in which the abnormality has been detected to any timing and re-executes the simulation in response to the instruction of re-execution.

5. The control system according to claim 1, wherein the processing circuitry is further configured to, in a case where a discontinuous singular point is detected in a locus of change of a state variable on a basis of the state variables in the calculation processes, and that the change of the state variable at the singular point is derived from information exchange of the coupled simulation on a basis of the cooperation information is detected, detect an abnormality having occurred in the coupled simulation at a generation timing of the singular point.

6. The control system according to claim 1, wherein a P2P type communication scheme is applied to communication between the plurality of simulators and communication between a wrapper unit and a second control unit, the wrapper unit executes simulation in the plurality of simulators and acquires information including state variables in calculation processes in the simulators and the second control unit controls information exchange between the plurality of simulators according to the causal relationship between the plurality of simulators and acquires cooperation information, which is information exchanged between the simulators.

7. A control method executed by a control system that controls a coupled simulation in which one simulation is constructed by combination of a plurality of simulators, the control method comprising:
managing a logical time for each of the simulators according to a causal relationship between the plurality of simulators, and giving an instruction to execute simulation in each of the simulators by using the logical time;
executing the simulation in the plurality of simulators and acquiring information including state variables in calculation processes in the simulators;
controlling information exchange between the plurality of simulators according to the causal relationship between the plurality of simulators and acquiring cooperation information, which is information exchanged between the simulators; and
analyzing presence or absence of an abnormality in the coupled simulation on a basis of the state variables in the calculation processes and the cooperation information.

8. A non-transitory computer-readable recording medium storing therein a control program for causing a computer to function as the control system according to claim 1.
